(19) United States
(12) Patent Application Publication
(10) Pub. No.: US 2015/0152558 A1
(43) Pub. Date: Jun. 4, 2015

(54) SUBSTRATE ELEMENT FOR COATING WITH AN EASY-TO-CLEAN COATING

(71) Applicants: Marten Walther, Alfeld (DE); Marta Krzyzak, Alfeld (DE)

(72) Inventors: Marten Walther, Alfeld (DE); Marta Krzyzak, Alfeld (DE)

(73) Assignee: SCHOTT AG, Mainz (DE)

(21) Appl. No.: 14/119,877

(22) PCT Filed: May 30, 2012
(86) PCT No.: PCT/EP2012/060106

§ 371 Date: Feb. 3, 2014

(30) Foreign Application Priority Data
May 31, 2011 (DE) 10 2011 076 756.8

(51) Int. Cl. C23C 18/12; C03C 17/42

(52) U.S. Cl. CPC C23C 18/1245; C23C 18/1212; C23C 18/1254; C03C 17/42

(57) ABSTRACT

A substrate element for coating with an easy-to-clean coating, the effect of the easy-to-clean coating being improved by the substrate element in terms of its hydrophobic and oleophobic properties and also, more particularly, its long-term stability. The substrate element comprises in particular a support material of glass or glass-ceramic and an adhesion promoter layer which is able to interact with an easy-to-clean coating and comprises a mixed oxide, more particularly a silicon mixed oxide.

### CROSS REFERENCE TO RELATED APPLICATIONS

This application is a U.S. National Stage Entry under 35 U.S.C. §371 of PCT/EP2012/060106, filed on May 30, 2012, which claims benefit under 35 U.S.C. §119(a) of German Patent Application No. 10 2011 076 756.8, filed May 31, 2011, the entire contents of both of which are incorporated herein by reference

### BACKGROUND OF THE INVENTION

1. Field of the Invention

The invention relates to a substrate element for coating with an easy-to-clean coating, comprising a support plate and an adhesion promoter layer disposed on the support plate, which adhesion promoter layer is suitable for interacting with an easy-to-clean coating. The invention further relates to a method for producing such a substrate element and to the use of such a substrate element.

2. Description of Related Art

The treatment of surfaces, more particularly of a transparent material such as glass or glass-ceramic, is acquiring ever greater significance, not least on account of the strongly growing market for contact or sensor image screens (touchscreens), as for example in the area of touch panel applications with interactive input. Here, the contact surfaces are required to meet the requirements of transparency and functionality, which in the multitouch applications segment, for example, are becoming ever more exacting. Touchscreens are finding use, for example, as a means of operating smart phones, automated teller machines, or as info monitors, such as for train time information at railroad stations, for example.

Touchscreens are also being used, furthermore, in games machines or for the control of machines in industry (industrial PCs), for example. The treatment of transparent glass or glass-ceramic surfaces is coming under the spotlight for all cover screens, but in particular for cover screens of mobile electronic products, such as, for example, for displays of notebooks, laptop computers, watches, or cell phones. For glass or glass-ceramic surfaces of, for example, refrigeration units, display windows, kiosks, or glass cabinets as well, however, surface treatment is increasingly acquiring importance. In all applications the aim is to ensure that good and hygienic functionality are secured without a high cleaning effort in conjunction with effective transparency with a high esthetic effect, something that is impaired, for example, by dirt and by residues from fingerprints.

One surface treatment is an etching of the glass surface, as known, for example, for antiglare screens. A disadvantage here, however, is a sharp drop in transparency and image resolution, since the structured surface means that the imaging light from the device to the viewer is also refracted and scattered by the display screen. To achieve high image resolution, further possible solutions are sought in the area of coating the surface with an easy-to-clean coating.

Standing in the foreground among the required qualities, especially for touchscreens, is the tactile and haptic perceptibility of the contact surface, which ought to be smooth, especially for multitouch applications. The key factor here is less any measurable roughness and more a tactile perceptibility by the user. Also in the foreground are a high transparency with low reflection behavior; a high level of dirt repellence and convenience of cleaning, especially a long-term durability of the easy-to-clean coating after use and after numerous cleaning cycles; scratch resistance and abrasion resistance, when input pens are used, for example, resistance to chemical exposures through finger perspiration, which contains salts and fats; and also the durability of any coating even under climatic and UV exposure. The easy-to-clean effect ensures that soiling arriving at the surface as a result of the environment or else as a result of natural use can easily be removed again, or else is dissuaded from remaining adhered to the surface. In this case the easy-to-clean surface has the property that soiling, as a result of fingerprints, for example, is very largely no longer visible and hence that the surface under use appears clean even without cleaning. This case, then, is a special case of the easy-to-clean surface: an antifingerprint surface. A contact surface must be resistant to deposits of water, salt, and fat, which arise in the use by users, for example, from residues of fingerprints. The wetting properties of a contact surface must be such that the surface is both hydrophobic and oleophobic.

The majority of known easy-to-clean coatings are essentially organofluorine compounds with a high contact angle with respect to water. Thus DE 198 48 591 describes, for the production of a protective layer of this kind, the use of an organofluorine compound of the formula R_{f}—V in the form of a liquid system comprising the organofluorine compound in a carrier liquid, with R_{f} in the formula R_{f}—V representing an aliphatic hydrocarbon radical which may be partly or fully fluorinated and may be straight-chain, branched-chain, or cyclic, it being possible for the hydrocarbon radical to be interrupted by one or more oxygen, nitrogen, or sulfur atoms. V represents a polar or dipolar group selected from —COOR, —COR, —COF, —CH₂OR, —OCOR, —CONR₂, —CN, —CONH—NR₂, —CON═C (NH₂)₂, —CH═NOR, —NRCONR₂, —NR₂COR, NR_{w}, —SO₃R, —OSO₂R, —OH, —SH, ≡B, —OP(OH)₂, —OPO(OH)₂, —OP(ONH₄)₂, —OPO(ONH₄)₂, —CO—CH═CH₂, in which R in a group V may be identical or different and represents hydrogen, a phenyl radical, or a straight-chain or branched-chain alkyl or alkyl ether radical that has up to 12, preferably up to 8, carbon atoms and may be partly or fully fluorinated or chlorofluorinated, and w is 2 or 3, or represents —RᵥV—. In the formula —Rᵥ—V—, V represents the above-indicated polar or dipolar group, and Rᵥ represents a straight-chain or branched-chain alkylene radical that has 1 up to 12, preferably up to 8, carbon atoms and that may be partly or fully fluorinated or chlorofluorinated.

EP 0 844 265, furthermore, describes a silicon-containing organic fluorine polymer for the coating of substrate surfaces such as those of metal, glass, and plastics materials, in order to endow a surface with sufficient and long-lasting antifouling qualities, sufficient weather resistance, lubricity, nonstick qualities, water repellence, and resistance to oily soiling and fingerprints. Also specified is a treatment solution for a surface treatment process, comprising a silicon-containing organic fluorine polymer, a fluorine-containing organic solvent, and a silane compound. Nothing is said concerning the suitability of a substrate surface for coating with an organic fluoropolymer of this kind.

US 2010/0279068 describes a fluoropolymer or a fluorosilane for antifingerprint coating. In this context, US 2010/0279068 already points out that the coating of a surface with such a coating alone is insufficient to provide the requisite surface properties for an antifingerprint coating. To solve the problem, US 2010/0279068 proposes that the surface of the glass article have a structure embossed therein or particles pressed into it. Such preparation of the surface for coating with an antifingerprint coating is very complicated and costly and generates unwanted stresses in the glass articles as a result of the thermal operations required.

US 2010/0285272 describes a polymer with low surface tension or an oligomer, such as a fluoropolymer or a fluorosilane, for antifinger coating. To prepare the surface for coating with an antifingerprint coating, a proposal is made to sandblast the glass surface and to apply thereon, by means of physical or chemical gas-phase deposition, a metal or metal oxide, such as tin oxide, zinc oxide, cerium oxide, aluminum, or zirconium. To prepare the surface for antifingerprint coating the further proposal is made that the metal oxide film applied by sputtering be etched, or that the metal film applied by vapor deposition be eloxed. The aim is to provide a stepped surface structure with two topological planes. The antifingerprint coating then constitutes a further stepped topological structure. These processes are likewise complicated and cost-intensive, and lead only to a hydrophobic and oleophobic surface featuring mechanical anchoring of the polymer by the structured surface, without sufficient account being taken of the other properties that are required.

US 2009/0197048 describes an antifingerprint coating or easy-to-clean coating on a glass cover, in the form of an outer coating with fluorine end groups, such as perfluorocarbon radical or a perfluorocarbon-containing radical, which gives the glass cover a degree of hydrophobicity and oleophobicity, thereby minimizing the wetting of the glass surface by water and oils. For the application of this coat to a glass surface, the proposal is made that the surface be cured chemically by means of ion exchange, by the intercalation in particular of potassium ions instead of sodium ions and/or lithium ions. Furthermore, the glass cover, beneath the antifingerprint or easy-to-clean coating, may include an antireflection layer composed of silicon dioxide, vitreous silica, fluorine-doped silicon dioxide, fluorine-doped vitreous silica, MgF₂, HfO₂, TiO₂, ZrO₂, Y₂O₃, or Gd₂O₃. It is also proposed that a texture or a pattern be generated on the glass surface prior to antifingerprint coating, by means of etching, lithography, or particle coating. Another proposal is that the glass surface be subjected to an acid treatment after ion exchange curing but before antifingerprint coating. These processes are likewise complicated and do not result in an easy-to-clean coating that satisfies the entirety of the properties required.

A particular disadvantage of such easy-to-clean layers in accordance with the prior art is the limited long-term durability of the layers, meaning that a rapid fall in the easy-to-clean properties is observed as a result of chemical and physical attack. This disadvantage is dependent not only on the nature of the easy-to-clean coating, but also on the nature of the substrate surface to which it is applied.

### SUMMARY

It is an object of the invention, therefore, to provide a substrate element that has a specific surface suitable for interacting with a multiplicity of easy-to-clean coatings in such a way that the properties of an easy-to-clean coating are improved, and the contact surface has the required properties to a sufficient degree, the production of such a substrate being inexpensive and simple.

The inventors have found that for an easy-to-clean coating that satisfies all of the required properties, a special adhesion promoter layer must be provided on the substrate element that is to be coated, which adhesion promoter layer is disposed on a support substrate, consists of a mixed oxide and has the property of interacting with an easy-to-clean coating that is to be applied later on.

The interaction is a chemical bonding, more particularly covalent bonding, between the adhesion promoter layer of the substrate of the invention and an easy-to-clean coating to be applied later, and has the effect of increasing the long-term stability of an easy-to-clean coating.

An easy-to-clean (ETC) coating, such as more particularly an antifingerprint (AFP) coating, is a coating which has a high dirt repellence quality, is readily cleanable, and may also exhibit an antigraffiti effect. The surface of the material in such an easy-to-clean coating exhibits resistants to deposits from, for example, fingerprints, such as liquids, salts, fats, dirt, and other materials. This refers both to the chemical resistance to such deposits and also to a low wetting behavior relative to such deposits. It refers, moreover, to the suppression, avoidance, or reduction of formation of fingerprints on contact by a user. Fingerprints contain, in particular, salts, amino acids, and fats, substances such as talc, perspiration, residues of dead skin cells, cosmetics, and lotions, and, in some cases, dirt in the form of liquid or particles of any of a very wide variety of kinds.

An easy-to-clean coating of this kind must therefore be resistant not only to water with salt but also to fatty and oily deposits and must have a low wetting behavior with respect to both. Attention must be paid in particular to high resistance in a salt water spray mist test. The wetting characteristics of a surface with an easy-to-clean coating must be such that the surface proves both to be hydrophobic—that is the contact angle between the surface and water is greater than 90°—and oleophobic—that is, the contact angle between the surface and oil is greater than 50°.

Prior-art solutions make use in particular, for the purpose of increasing the contact angle, of the effect known as the lotus effect. This is based on a dual structure of the surface, as a result of which the contact area and hence the force of adhesion between the surface and particles and water droplets lying on it are greatly reduced. This dual structure is formed by a characteristically shaped surface structure in the range from about 10 to 20 micrometers, and by an easy-to-clean coating applied to said structure. The wetting behavior of liquids on solid roughened surfaces may be described either, for low contact angles, by the Wenzel model, or, for high contact angles, by the Cassie-Baxter model, as set out for example by US 2010/0285272. In contrast to this structural effect, the invention solves the problem by a chemically based route.

In one preferred embodiment, the adhesion promoter layer is a liquid-phase coating, more particularly a thermally consolidated sol-gel layer. The adhesion promoter layer may alternatively be a CVD coating (layer application by plasma-assisted chemical gas-phase deposition) which is produced, for example, by means of PECVD, PICVD, low-pressure CVD, or chemical gas-phase deposition at atmospheric pressure. The adhesion promoter layer may alternatively be a PVD coating (layer application by plasma-assisted physical gas-phase deposition), which is produced for example by means of sputtering, thermal vaporization, or laser-beam, electron-beam, or light-arc vaporization. The adhesion promoter layer may alternatively be a flame pyrolysis layer.

In one preferred embodiment, the adhesion promoter layer is a silicon mixed oxide layer, the admixture preferably being an oxide of at least one of the elements aluminum, tin, magnesium, phosphorus, cerium, zirconium, titanium, cesium, barium, strontium, niobium, zinc, boron and/or magnesium fluoride, preferably including at least one oxide of the element aluminum. In the case of a silicon-aluminum mixed oxide layer, the molar ratio of aluminum to silicon in the mixed oxide is between about 3% and about 30%, preferably between about 5% and about 20%, more preferably between about 7% and about 12%.

Silicon oxide for the purposes of this invention is any silicon oxide between silicon monoxide and silicon dioxide. Silicon for the purposes of the invention is understood as a metal and as a semimetal. Silicon mixed oxide is a mixture of a silicon oxide with an oxide of at least one other element, and may be homogeneous or nonhomogeneous, stoichiometric or nonstoichiometric.

An adhesion promoter layer of this kind has a layer thickness of greater than 1 nm, preferably greater than 10 nm, more preferably greater than 20 nm. The critical factor here is that, taking account of the depth of the interaction with the easy-to-clean coating, the adhesion promoter function of the layer can be fully exploited.

An adhesion promoter layer of this kind has a refractive index in the range from 1.35 to 1.7, preferably in the range from 1.35 to 1.6, more preferably in the range from 1.35 to 1.56 (for a 588 nm reference wavelength).

The adhesion promoter layer of the invention may be applied preferably by a sol-gel process or else by a process involving chemical or physical gas-phase deposition, more particularly by sputtering.

It is a great advantage of the invention that if the substrate consists of or comprises glass, this glass as well may also be thermally prestressed and hence thermally hardened after coating has taken place, without the coating suffering notably damage as a result. Thermal hardening is accomplished preferably by bringing at least that region of the glass that is to be hardened, dependent on the thickness of the glass, to a temperature of about 600° C. to about 750° C., preferably to a temperature of about 670° C., for a period, for example of about 2 min to 6 min, preferably of 4 min.

A further great advantage of the invention lies in the fact that, in the case of production of the adhesion promoter layer by a liquid-phase coating, more particularly by a sol-gel coating, the thermal consolidation of the coating can take place in situ with a heat treatment of the support material. This implies cost-effective production.

If the surface of the support material is activated before the adhesion promoter layer is applied, more particularly as a sol-gel layer, the adhesion of applied layer may be improved as a result. The treatment may take place advantageously by means of a washing operation or else in the form of activation by corona discharge, flame treatment, UV treatment, plasma activation and/or mechanical methods, such as roughening, sandblasting and/or chemical methods, such as etching.

In one embodiment there is at least one barrier layer disposed between the adhesion promoter layer and the support material, the barrier layer taking the form more particularly of an alkali metal barrier layer, more particularly a sodium barrier layer. The thickness of such a barrier layer is in the range between 3 and 100 nm, preferably between 5 and 50 nm, and more particularly between 10 and 35 nm. The barrier layer preferably comprises a metal oxide and/or semimetal oxide. More particularly a barrier layer is formed substantially of silicon oxide and/or titanium oxide and/or tin oxide. A barrier layer of this kind is applied by means of flame pyrolysis, by a process of physical (PVD) or by a process of chemical (CVD) gas-phase deposition, or else by means of a sol-gel process. Such a barrier layer is preferably in the form substantially of a glass layer.

Also part of the invention is an adhesion promoter layer which is subdivided into sublayers by one or more very thin interlayers. This serves in particular to prevent stress within the adhesion promoter layer. For example, it may be divided by one or more pure silicon oxide interlayers. The thickness of such an interlayer is 0.3 to 10 nm, preferably 1 to 3 nm, more preferably 1.5 to 2.5 nm.

In one embodiment the adhesion promoter layer may be provided with an outer layer. An outer layer of this kind must be embodied such that through the outer layer there is sufficient possibility of interaction between the adhesion promoter layer and an easy-to-clean layer; in other words, a chemical bond, more particularly a covalent bond, between the adhesion promoter layer and an easy-to-clean coating for later application. Layers of this kind are, for example, porous sol-gel layers or thin, partly pervious oxide layers applied by flame pyrolysis. The layer may also be a supportingly structure-imparting layer for the easy-to-clean coating that can be applied later. An outer layer of this kind may be configured as a particulate or porous layer. It is of advantage in particular to produce such an outer layer from silicon oxide, in which case the silicon oxide may also be a silicon mixed oxide, more particularly a silicon oxide mixed with an oxide of at least one of the elements aluminum, tin, magnesium, phosphorus, cerium, zirconium, titanium, cesium, barium, strontium, niobium, zinc, boron, or with magnesium fluoride. Suitable for producing such an outer layer is, for example, a coating by flame pyrolysis, other thermal coating processes, cold gas spraying, or else sputtering, for example.

Suitable support materials for the application of an adhesion promoter layer of the invention are in principle all suitable materials, such as a metal, a plastic, a crystal, a ceramic, or a composite material. A glass or a glass-ceramic is preferred, however. With particular preference here a glass is used which has been prestressed for its use. This glass may have been prestressed chemically by ion exchange or thermally. Especially preferred are low-iron soda-lime glasses, borosilicate glasses, aluminum silicate glasses, lithium aluminum silicate glasses, and glass-ceramic, obtained for example by means of drawing methods, such as updraw or downdraw methods, overflow fusion, float technology, or from a cast or rolled glass. Especially in the case of the casting or rolling process or in the case of a floated glass, the required optical quality of the surface, as required, for example, for a display front screen, may be obtained by way of a polishing technology.

Use may be made advantageously of a low-iron or iron-free glass, more particularly with an Fe₂O₃ content of less than 0.05 wt %, preferably less than 0.03 wt %, since this glass has reduced absorption and therefore, in particular, allows enhanced transparency.

For other applications, however, gray glasses or colored glasses are also preferred. The support materials, more particularly glasses, may be transparent, translucent, or else opaque. For whiteboard deployment, for example, the use of a glass with a milky appearance is preferred, such as that available from Schott AG, Mainz as Opalika®.

Outstanding optical properties in the ultraviolet spectral range may be achieved if the support material is a vitreous silica. Also serving as support material may be an optical glass, such as a heavy flint glass, heavy lanthanum flint glass, flint glass, lightweight flint glass, crown glass, borosilicate crown glass, barium crown glass, heavy crown glass, or fluorine crown glass.

Preference is given to the use as support material of lithium aluminum silicate glasses of the following glass compositions, consisting of (in wt %)

| | |
|---|---|
| SiO₂ | 55-69 |
| Al₂O₃ | 19-25 |
| Li₂O | 3-5 |
| Total of Na₂O + K₂O | 0-3 |
| Total of MgO + CaO + SrO + BaO: | 0-5 |
| ZnO | 0-4 |
| TiO₂ | 0-5 |
| ZrO₂ | 0-3 |
| Total of TiO₂ + ZrO₂ + SnO₂ | 2-6 |
| P₂O₅ | 0-8 |
| F | 0-1 |
| B₂O₃ | 0-2, |

and also, optionally, additions of coloring oxides, such as, for example, Nd₂O₃, Fe₂O₃, CoO, NiO, V₂O₅, Nd₂O₃, MnO2, TiO2, CuO, CeO2, Cr₂O₃, rare earth oxides in amounts of 0-1 wt %, and also refining agents such as As₂O₃, Sb₂O₃, SnO₂, SO₃, Cl, F, CeO₂ of 0-2 wt %.

As support material it is also preferred to use soda-lime silicate glasses of the following glass compositions, consisting of (in wt %)

| | |
|---|---|
| SiO₂ | 40-80 |
| Al₂O₃ | 0-6 |
| B₂O₃ | 0-5 |
| Total of Li₂O + Na₂O + K₂O | 5-30 |
| Total of MgO + CaO + SrO + BaO + ZnO: | 5-30 |
| Total TiO₂ + ZrO₂ | 0-7 |
| P₂O₅ | 0-2 |

and also, optionally, additions of coloring oxides, such as, for example, Nd₂O₃, Fe₂O₃, CoO, NiO, V₂O₅, Nd₂O₃, MnO2, TiO2, CuO, CeO2, Cr₂O₃, rare earth oxides in amounts of 0-5 wt %, or for “black glass”, of 0-15 wt %, and also refining agents such as As₂O₃, Sb₂O₃, SnO₂, SO₃, Cl, F, CeO₂ of 0-2 wt %.

As support material it is also preferred to use borosilicate glasses of the following glass compositions, consisting of (in wt %)

| | |
|---|---|
| SiO₂ | 60-85 |
| Al₂O₃ | 1-10 |
| B₂O₃ | 5-20 |
| Total of Li₂O + Na₂O + K₂O | 2-16 |
| Total of MgO + CaO + SrO + BaO + ZnO: | 0-15 |
| Total TiO₂ + ZrO₂ | 0-5 |
| P₂O₅ | 0-2 |

and also, optionally, additions of coloring oxides, such as, for example, Nd₂O₂, Fe₂O₃, CoO, NiO, V₂O₅, Nd₂O₂, MnO2, TiO2, CuO, CeO2, Cr₂O₃, rare earth oxides in amounts of 0-5 wt %, or for “black glass”, of 0-15 wt %, and also refining agents such as As₂O₃, Sb₂O₃, SnO₂, SO₃, Cl, F, CeO₂ of 0-2 wt %.

As support material it is also preferred to use alkali metal aluminosilicate glasses of the following glass compositions, consisting of (in wt %)

| | |
|---|---|
| SiO₂ | 40-75 |
| Al₂O₃ | 10-30 |
| B₂O₃ | 0-20 |
| Total of Li₂O + Na₂O + K₂O | 4-30 |
| Total of MgO + CaO + SrO + BaO + ZnO: | 0-15 |
| Total TiO₂ + ZrO₂ | 0-15 |
| P₂O₅ | 0-10 |

and also, optionally, additions of coloring oxides, such as, for example, Nd₂O₂, Fe₂O₃, CoO, NiO, V₂O₅, Nd₂O₂, MnO2, TiO2, CuO, CeO2, Cr₂O₃, rare earth oxides in amounts of 0-5 wt %, or for “black glass”, of 0-15 wt %, and also refining agents such as As₂O₃, Sb₂O₃, SnO₂, SO₃, Cl, F, CeO₂ of 0-2 wt %.

As support material it is also preferred to use alkali-metal free aluminosilicate glasses of the following glass compositions, consisting of (in wt %)

| | |
|---|---|
| SiO₂ | 50-75 |
| Al₂O₃ | 7-25 |
| B₂O₃ | 0-20 |
| Total of Li₂O + Na₂O + K₂O | 0-0.1 |
| Total of MgO + CaO + SrO + BaO + ZnO: | 5-25 |
| Total TiO₂ + ZrO₂ | 0-10 |
| P₂O₅ | 0-5 |

and also, optionally, additions of coloring oxides, such as, for example, Nd₂O₂, Fe₂O₃, CoO, NiO, V₂O₅, Nd₂O₂, MnO2, TiO2, CuO, CeO2, Cr₂O₃, rare earth oxides in amounts of 0-5 wt %, or for “black glass”, of 0-15 wt %, and also refining agents such as As₂O₃, Sb₂O₃, SnO₂, SO₃, Cl, F, CeO₂ of 0-2 wt %.

As support material it is also preferred to use low alkali-metal aluminosilicate glasses of the following glass compositions, consisting of (in wt %)

| | |
|---|---|
| SiO₂ | 50-75 |
| Al₂O | 7-25 |
| B₂O₃ | 0-20 |
| Total of Li₂O + Na₂O + K₂O | 0-4 |
| Total of MgO + CaO + SrO + BaO + ZnO: | 5-25 |
| Total TiO₂ + ZrO₂ | 0-10 |
| P₂O₅ | 0-5 |

and also, optionally, additions of coloring oxides, such as, for example, Nd₂O₂, Fe₂O₃, CoO, NiO, V₂O₅, Nd₂O₂, MnO2, TiO2, CuO, CeO2, Cr₂O₃, rare earth oxides in amounts of 0-5 wt %, or for “black glass”, of 0-15 wt %, and also refining agents such as As₂O₃, Sb₂O₃, SnO₂, SO₃, Cl, F, CeO₂ of 0-2 wt %.

For display glass applications, especially touch panels or touchscreens, in small format it is preferred for the substrate to have a thickness 1 mm and more particularly to be an ultrathin substrate. Particularly preferred, for example, are thin glasses and ultrathin glasses of the kind sold by Schott AG, Mainz under the designations D263, B270, Borofloat, Xensation Cover, or Xensation cover 3D. Ultrathin glasses have a thickness of 0.02 to 1.3 mm. Preferred are thicknesses of 0.03 mm, 0.05 mm, 0.07 mm, 0.1 mm, 0.145 mm, 0.175 mm, 0.21 mm, 0.3 mm, 0.4 mm, 0.55 mm, 0.7 mm, 0.9 mm, 1.1 mm, 1.2 mm or 1.3 mm.

In the case of intended application for cover screens for displays, as touch panels or touchscreens for more extensive areas, as for example areas of more than 1 m², it is preferred to use support materials having a thickness of 3 to 6 mm, thereby taking on part of the mechanical protective function of the display.

The support materials may be either single sheets or composite sheets. A composite sheet comprises, for example, first and second sheets joined by a PVB film, for example. Of the outwardly directed surfaces of the composite sheet, at least one surface is furnished with an adhesion promoter layer of the invention. Particularly preferred is the application of direct lamination to, for example, the polarizer of a display.

The surfaces of the support materials may have been polished or else textured, as for example by etching, depending on the surface properties required in order to meet the requirements of good tactile qualities.

A further suitable support material is a partly or fully mirrored surface. In this case the effect of an easy-to-clean or antifingerprint coating with long-term stability is manifested to a particular degree.

Moreover, the surface of the support material may also have a scratch resistance coating, such as a silicon nitrite coating, for example.

Furthermore, a support material, more particularly the surface of a support material, may also have an electrically conductive coating, of the kind advantageous for a variety of applications, as for example in the case of touchscreens which operate on a capacitive basis. Such coatings are, in particular, coatings with one or more metal oxides such as ZnO:Al, ZnO:B, ZnO:Ga, ZnO:F, SnOₓ:F, SnGₓ:Sb, and ITO (In₂O₃:SnO₂). It is also possible, however, for one or more thin metal layers to be applied as a conductive coating on a support material, such as aluminum, silver, gold, nickel, or chromium, for example.

The invention also provides a method for producing a substrate for coating with an easy-to-clean coating. A process of this kind comprises the following steps:

First of all a support material is provided, more particularly composed of a glass or a glass-ceramic. It is, however, also possible to provide a metal, a plastic, or any material that meets the requirements of the coating process. The surface of surfaces to be coated are cleaned. Cleaning with liquids is a widespread procedure in connection with glass substrates. A variety of cleaning liquids are used here, such as demineralized water or aqueous systems such as dilute alkalis (pH>9) and acids, detergent solutions, or nonaqueous solvents such as alcohols or ketones, for example.

In a further embodiment of the invention, the support material may also be activated prior to coating. Activation methods of this kind include oxidation, corona discharge, flame treatment, UV treatment, plasma activation and/or mechanical methods, such as roughening, sandblasting, and also plasma treatments or else treatment of the substrate surface for activation with an acid and/or an alkali.

The adhesion promoter layer is applied by means of a method of physical or chemical gas-phase deposition, by means of flame pyrolysis or of a sol-gel process. In the latter case, the adhesion promoter layer may be applied to the surface by dipping, vapor coating, spraying, printing, roller application, in a wiping process, a spreading process or a rolling process and/or knifecoating process, or by another suitable method. Immersion and spraying are preferred.

The preferred sol-gel process utilizes a reaction of metal-organic starting materials in the dissolved state to form the layer. As a result of controlled hydrolysis and condensation reaction of the metal-organic starting materials, a metal oxide network structure is built up, i.e., a structure in which the metal atoms are joined to one another by oxygen atoms, in tandem with the elimination of reaction products such as alcohol and water. The hydrolysis reaction here can be accelerated by addition of catalysts.

In one preferred embodiment the support material during sol-gel coating is withdrawn from the solution with a drawing speed of about 200 mm/min to about 900 mm/min, preferably of about 300 mm/min, with the moisture content of the atmosphere being between about 4 g/m3 and about 12 g/m3, more preferably being about 8 g/m3.

If the sol-gel coating solution is to be stored or else utilized for an extended period, it is advantageous to stabilize the solution by adding one or more complexing agents. These complexing agents must be soluble in the dipping solution, and advantageously are to be related to the solvent of the dipping solution. Preference is given to organic solvents which at the same time possess complex-forming properties, such as methyl acetate, ethyl acetate, acetylacetone, ethyl acetoacetate, ethyl methyl ketone, acetone, and similar compounds. These stabilizers are added to the solution in amounts of 1 to 1.5 ml/l.

### BRIEF DESCRIPTION OF THE DRAWINGS

FIG. 1 is a first embodiment of a substrate element according to the present application; and

FIG. 2 is a second embodiment of a substrate element according to the present application

### DETAILED DESCRIPTION

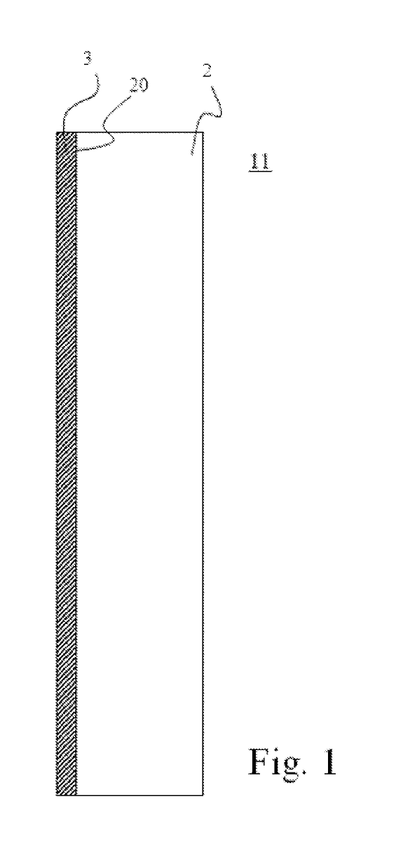

In one preferred configuration corresponding, for example, to FIG. 1, for the production of a substrate element 11, an adhesion promoter layer 3 of this kind is applied by dip coating in accordance with the sol-gel principle. In this case, for the production of a silicon mixed oxide layer as adhesion promoter layer 3 on the at least one surface 20 of the prepared, washed support material 2, e.g. of a sheet of glass, said support material is dipped into an organic solution containing a hydrolysable compound of silicon. The support material is then withdrawn from this solution at a uniform rate into a moisture-comprising atmosphere. The layer thickness of the silicon mixed oxide adhesion promoter precursor layer that forms is determined by the concentration of the silicon starting compound in the dipping solution and by the drawing rate. The layer can be dried after application, to achieve higher mechanical strength on transfer to the high-temperature oven. This drying may take place within a wide temperature range. It typically requires drying times of a few minutes at temperatures in the region of 200° C. Lower temperatures result in longer drying times. It is also possible to go straight from the application of the layer to the process step of thermal consolidation in the high-temperature oven. The drying step in that case serves for mechanical stabilization of the coating.

The formation of the substantially oxidic adhesion promoter layer from the applied gel film takes place in the high-temperature step, in the course of which organic constituents of the gel are burnt out. Here, then, in order to produce the eventual silicon mixed oxide layer or mixed oxide layer as adhesion promoter layer, the adhesion promoter precursor layer is baked at temperatures below the softening temperature of the support material, preferably at temperatures less than 550° C., more particularly between 350 and 500° C., very preferably between 400 and 500° C. substrate surface temperature. Depending on the softening temperature of the glass base, it is also possible for temperatures of more than 550° to be employed. Such temperatures, however, make no contribution to a further increase in the strength of adhesion.

The production of thin oxide layers from organic solutions has been well known for many years—in this regard see, for example B. H. Schröder, Physics of Thin Films 5, Academic Press New York and London (1967, pages 87-141) or else U.S. Pat. No. 4,568,578.

The inorganic sol-gel material from which the sol-gel layer is produced is preferably a condensate, more particularly comprising one or more hydrolysable and condensable or condensed silanes and/or metal alkoxides, preferably of Si, Ti, Zr, Al, Nb, Hf and/or Ge. With preference, the groups crosslinked in the sol-gel process by way of inorganic hydrolysis and/or condensation may be, for example, the following functional groups: TiR4, ZrR4, SiR4, AlR3, TiR3(OR), TiR2(OR)2, ZrR2(OR)2, ZrR3(OR), SiR3(OR), SiR2(OR)2, TiR(OR)3, ZrR(OR)3, AlR2(OR), AlR1(OR)2, Ti(OR)4, Zr(OR)4, Al(OR)3, Si(OR)4, SiR(OR)3 and/or Si2(OR)6, and/or one of the following substances or groups of substance with OR: alkoxy such as, preferably, methoxy, ethoxy, n-propoxy, isopropoxy, butoxy, isopropoxyethoxy, methoxypropoxy, phenoxy, acetoxy, propionyloxy, ethanolamine, diethanolamine, tiethanolamine, methacryloyloxypropyl, acrylate, methacrylate, acetylacetone, ethyl acetoacetate, ethoxyacetate, methoxyacetate, methoxyethoxyacetate and/or methoxyethoxyethoxyacetate, and/or one of the following substances or groups of substances with R: Cl, Br, F, methyl, ethyl, phenyl, n-propyl, butyl, allyl, vinyl, glycidylpropyl, methacryloyloxypropyl, aminopropyl and/or fluoroctyl.

A common feature of all sol-gel reactions is that molecularly disperse precursors first undergo hydrolysis, condensation, and polymerization reactions to form particularly disperse or colloidal systems. Depending on the selected conditions, “primary particles” formed first of all may grow further, may undergo aggregation to form clusters, or may form more linear chains. The resulting units cause microstructures which arise as a result of the removal of the solvent. In an ideal case, the material may be fully compacted thermally, but in reality there often remains a degree—in some cases, a considerable degree—of residual porosity. The chemical conditions during sol production therefore have a critical influence on the properties of a sol-gel coating as described by P. Löbmann, “Sol-Gel-Beschichtungen”, Fortbildungskurs 2003 “Oberflächen Veredelung von Glas”, Hüttentechnische Vereinigung der deutschen Glasindustrie.

Si starting materials have been very well investigated to date; in this regard, see C. Brinker, G. Scherer, “Sol-Gel-Science—The Physics and Chemistry of Sol-Gel Processing (Academic Press, Boston 1990), R. Iller, The Chemistry of Silica (Wiley, New York, 1979). The Si starting materials used the most are silicon alkoxides in the formula Si(OR)4, which hydrolyze on addition of water. Under acidic conditions, linear assemblies are formed preferentially. Under basic conditions, the silicon alkoxides react to form more highly crosslinked “globular” particles. The sol-gel coatings contain precondensed particles and clusters.

For the preparation of a silicon oxide dipping solution, the starting compound customarily used is tetraethyl silicate or methyl silicate. This silicate is admixed with an organic solvent, such as ethanol, with hydrolysis water, and with acid as catalyst, in the stated order, and the components are thoroughly mixed. The hydrolysis water is preferably admixed with mineral acids such as HNO₃, HCl or H₂SO₄ or with organic acids such as acetic acid, ethoxy acetic acid, methoxy acetic acid, polyethercarboxylic acids (e.g., ethoxyethoxy acetic acid), citric acid, para-toluenesulfonic acid, lactic acid, methacrylic acid, or acrylic acid.

In one particular embodiment the hydrolysis is carried out wholly or partly in the alkaline range, with use for example of NH₄OH and/or of tetramethylammonium hydroxide and/or NaOH.

To produce the adhesion promoter layer for the substrate of the invention, the dipping solution is produced as follows: The silicon starting compounds are dissolved in an organic solvent. Solvents used may be all organic solvents which dissolve the silicon starting compound and are capable as well of dissolving a sufficient amount of water, which is needed for the hydrolysis of the silicon starting compound. Suitable solvents are, for example, toluene, cyclohexane, or acetone, but especially C1-C6 alcohols, examples being methanol, ethanol, propanol, butanol, pentanol, hexanol, or isomers thereof. It is usual to use lower alcohols, especially methanol and ethanol, since they are easy to handle and possess a relatively low vapor pressure. The silicon starting compound employed is, in particular, C1-C4 alkyl ester of silicic acid, i.e., methyl silicate, ethyl silicate, propyl silicate or butyl silicate. Methyl silicate is preferred.

The concentration of the silicon starting compound in the organic solvent is customarily about 0.05-1 mol/liter. For the purpose of hydrolysis of the silicon starting compound, this solution is admixed with 0.05-12 wt % of water, preferably distilled water, and with 0.01-7 wt % of an acidic catalyst. Added to this are preferably organic acids such as acetic acid, ethoxy acetic acid, methoxy acetic acid, polyethercarboxylic acids (e.g., ethoxyethoxy acetic acid), citric acid, para-toluenesulfonic acid, lactic acid, methylacrylic acid, or acrylic acid or mineral acids such as HNO₃, HCl, or H₂SO₄, for example.

The pH value of the solution ought approximately to be between pH 0.5 and pH 3. If the solution is not sufficiently acidic (pH>3), the risk exists of the polycondensates/clusters becoming enlarged. If the solution is too acidic, the risk exists of the solution gelling.

In a further embodiment the solution may be prepared in two steps. The first step takes place as described above. This solution is then left to stand (aged). The aging time is achieved by diluting the aged solution with further solvent and halting the aging by shifting the pH of the solution into the strongly acidic range. Shift into a pH range of 1.5 to 2.5 is preferred. The shifting of the pH into the strongly acidic range is accomplished preferably by addition of an inorganic acid, more particularly by addition of hydrochloric acid, nitric acid, sulfuric acid, or phosphoric acid, or else of organic acids, such as oxalic acid or the like, for example. The strong acid is preferably added in an organic solvent, more particularly in the solvent in which the silicon starting compound is dissolved as well. It is also possible here to add the acid in a sufficient amount of solvent, more particularly again in alcoholic solution, such that the diluting of the starting solution and the stopping take place in one step.

In one particular embodiment the hydrolysis is carried out wholly or partly in the alkaline range, with use, for example, of NH₄OH and/or tetramethylammonium hydroxide and/or NaOH.

The sol-gel coatings comprise precondensed particles and clusters, which may have various structures. These structures can in fact be detected using scattered light experiments. By means of operational parameters such as temperature, metering rates, stirring speed, but especially through the pH value, it is possible for these structures to be produced in sols. It has emerged that using small silicon oxide polycondensates/clusters, having a diameter of less than or equal to 20 nm, preferably less than or equal to 4 nm, and more preferably in the range from 1 to 2 nm, it is possible to produce dipped layers which are more densely packed than silicon oxide layers conventionally. Even this leads to an improvement in the chemical stability.

A further improvement in the chemical stability and in the adhesion promoter layer function is achieved by treating the solution with small amounts of an admixture agent which is dispersed homogeneously in the solution and is also dispersed in the later layer, where it forms a mixed oxide. Suitable admixture agents are hydrolysable or dissociating inorganic salts, optionally with water of crystallization, of tin, aluminum, phosphorus, boron, cerium, zirconium, titanium, cesium, barium, strontium, niobium, or magnesium, e.g., SnCl₄, SnCl₂, AlCl₃, Al(NO₃)₃, Mg(NO₃)₂, MgCl₂, MgSO₄, TiCl₄, ZrCl₄, CeCl₃, Ce(NO₃)₃, and the like. These inorganic salts can be used both in hydrous form and with water of crystallization. They are generally preferred on account of their low price.

In a further embodiment according to the invention the admixture agent used may be one or more of the metal alkoxides of tin, aluminum, phosphorus, boron, cerium, zirconium, titanium, cesium, barium, strontium, niobium, or magnesium, preferably of titanium, zirconium, aluminum, or niobium. Also suitable are phosphoric esters, such as methyl phosphate or ethyl phosphate, phosphorus halides, such as chlorides and bromides, boric esters, such as ethyl, methyl, butyl, or propyl esters, boric anhydride, BBr₃, BCl₃, magnesium methoxide or ethoxide, and the like.

These one or more admixture agents are added, for example, in a concentration of about 0.5-20 wt %, calculated as oxide, based on the silicon content of the solution, calculated as SiO′. The admixture agents can in each case also be used in any desired combination with one another.

If the dipping solution is to be stored or else used over a prolonged period, it may be advantageous if the solution is stabilized by addition of one or more complexing agents. These complexing agents must be soluble in the dipping solution and are advantageously to be related to the solvent of the dipping solution.

Complexing agents which can be used include, for example, ethyl acetoacetate, 2,4-pentanedione (acetylacetone), 3,5-heptanedione, 4,6-nonanedione, or 3-methyl-2,4-pentanedione, 2-methylacetylacetone, triethanolamine, diethanolamine, ethanolamine, 1,3-propanediol, 1,5-pentanediol, carboxylic acids such as acetic acid, propionic acid, ethoxyacetic acid, methoxyacetic acid, polyethercarboxylic acids (e.g., ethoxyethoxyacetic acid), citric acid, lactic acid, methylacrylic acid, and acrylic acid.

The molar ratio of complexing agent to semimetal oxide precursor and/or metal oxide precursor is 0.1 to 5.

### Examples

The finished layers were produced as follows: a float glass sheet scrupulously cleaned in a washing operation, in 10×20 cm format, was dipped into the respective dipping solution. The sheet was then withdrawn again at a rate of 6 mm/sec, the moisture content of the ambient atmosphere being between 4 g/m³ and 12 g/m³, preferably 8 g/m³. The solvent was subsequently evaporated at 90 to 100° C. and the layer thereafter was baked at a temperature of 450° C. for 20 minutes. The thickness of the layers produced in this way was about 90 nm.

### Preparation of Example Solutions:

### 1^{st} Dipping Solution

125 ml of ethanol are introduced. Added thereto with stirring are 45 ml of methyl silicate, 48 ml of distilled water, and 6 ml of glacial acetic acid. Following the addition of water and acetic acid, the solution is stirred for 4 hours, during which the temperature must not exceed 40° C. It may be necessary to cool the solution. The reaction solution is subsequently diluted with 675 ml of ethanol and admixed with 1 ml of HCl. Added to this solution then are 10 g of SnCl₄×6 H₂O in solution in 95 ml of ethanol and 5 ml of acetylacetone.

### 2nd Dipping Solution

125 ml of ethanol are introduced. Added thereto with stirring are 45 ml of methyl silicate, 48 ml of distilled water, and 1.7 g of 37% strength HCl. Following the addition of water and hydrochloric acid, the solution is stirred for 10 minutes, during which the temperature must not exceed 40° C. It may be necessary to cool the solution. The reaction solution is subsequently diluted with 675 ml of ethanol. Added to this solution then are 10 g of SnCl₄×6 H₂O in solution in 95 ml of ethanol and 5 ml of acetylacetone.

3rd Dipping Solution

Added with stirring to 125 ml of ethanol are 60.5 ml of tetraethyl silicate, 30 ml of distilled water, and 11.5 g of 1 N nitric acid. Following the addition of water and nitric acid, the solution is stirred for 10 minutes, during which the temperature must not exceed 40° C. It may be necessary to cool the solution. The solution is subsequently diluted with 675 ml of ethanol. Added to this solution after 24 hours are 10.9 g of Al(NO₃)₃×9 H₂O in solution in 95 ml of ethanol and 5 ml of acetylacetone.

### 4th Dipping Solution

Added with stirring to 125 ml of ethanol are 60.5 ml of tetraethyl silicate, 30 ml of distilled water, and 11.5 g of 1 N nitric acid. Following the addition of water and nitric acid, the solution is stirred for 10 minutes, during which the temperature must not exceed 40° C. It may be necessary to cool the solution. The solution is subsequently diluted with 675 ml of ethanol. Added to this solution are 9.9 g of tetrabutyl orthotitanate in solution in 95 ml of ethanol and 4 g of ethyl acetate.

In a further preferred embodiment a solution of silicon mixed oxide is applied to a support substrate and consolidated thermally in the course of a thermal prestressing operation. The thermal consolidation of the sol-gel layer takes place in situ, with a subsequent thermal prestressing of the substrate at substrate surface temperatures of more than 500° C. This entails a very cost-effective production, since the prestressing and the thermal consolidation of the adhesion promoter layer take place in one operation. The oven temperature here is about 650° C., depending on the temperature-time curve. The temperature treatment is followed by a shock cooling.

With the abovementioned solutions, chemically and mechanically stable mixed oxide layers are obtained, as adhesion promoter layer, and, in the case of an admixture to form aluminum-silicon mixed oxide layers, the molar ratio of aluminum to silicon in the mixed oxide is between about 3% to about 30%, preferably between about 5% and about 20%, more preferably between about 7% and about 12%.

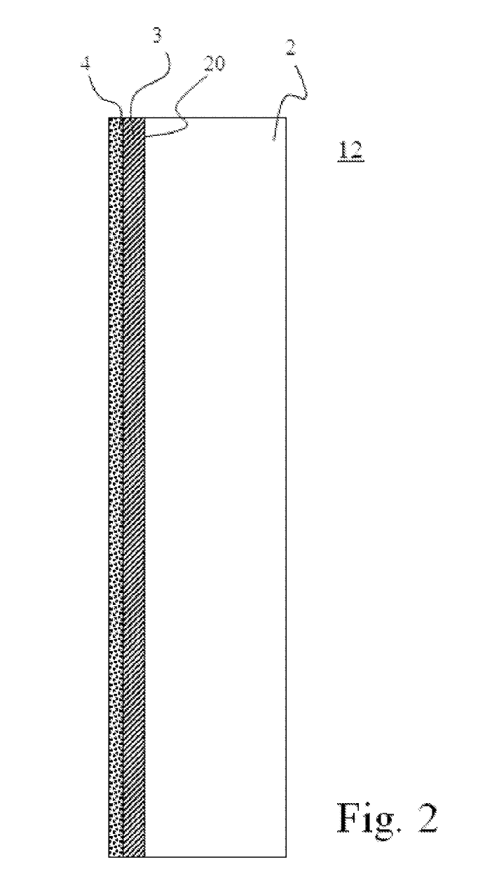

In a further embodiment of the invention, for the production of a substrate element 12, as shown, for example, by FIG. 2, in addition to the example corresponding to FIG. 1, an outer layer 4, in the form of a particulate or porous layer, is applied to the adhesion promoter layer 3. This takes place by means, more particularly, of coating by flame pyrolysis, by a thermal coating process, cold-gas spraying or sputtering, with the outer layer 4 consisting preferably of silicon oxide. This outer layer may also consist of a silicon mixed oxide. An example of a suitable admixture is an oxide of at least one of the elements aluminum, tin, magnesium, phosphorus, cerium, zirconium, titanium, cesium, barium, strontium, niobium, zinc, boron, or magnesium fluoride.

Owing to the sufficient open porosity of the outer layer 4, it is possible, on application of an easy-to-clean layer, when the substrate element 12 is used, for there to be interaction between the molecules of the easy-to-clean coating and of the adhesion promoter layer, ensuring the higher long-term stability of the easy-to-clean coating.

The invention also provides the use of a substrate element of the invention for coating with an easy-to-clean coating, more particularly with an organofluorine compound. Said substrate element comprises a support plate, more particularly of glass or glass-ceramic, and an adhesion promoter layer which comprises a mixed oxide, preferably a silicon mixed oxide, more preferably a silicon oxide mixed with an oxide of at least one of the elements aluminum, tin, magnesium, phosphorus, cerium, zirconium, titanium, cesium, barium, strontium, niobium, zinc, boron or with magnesium fluoride, including preferably at least one oxide of the element aluminum.

In an embodiment of the use of a substrate element of the invention for coating with an easy-to-clean coating, an outer layer is disposed over the adhesion promoter layer. This outer layer is a particulate or porous layer, more particularly of silicon oxide, and the silicon oxide may also be a silicon mixed oxide.

Substrates of the invention of this kind find use for coating with an easy-to-clean coating. This easy-to-clean coating may more particularly be an antifingerprint coating or an antistick coating. In the case of antistick coatings, the layers have a very smooth effect, and so mechanical surface protection is achieved. The layers referred to below customarily have two or more properties from the range of easy-to-clean, antistick, antifingerprint, antiglare, or smoothing surface. Each of the products is more suitable in one area, and so, through the choice of the correct type of easy-to-clean coating in conjunction with the substrate element of the invention, products can be obtained that have optimized easy-to-clean properties with particular long-term durability.

Easy-to-clean coatings are available diversely on the market. In particular there are organofluorine compounds, as described by DE 198 48 591, for example. Known easy-to-clean coatings are products based on perfluoropolyethers under the designation “Fluoroline PFPE” such as “Fluoroline S10” from Solvay Solexis or else “Optool™ DSX” or “Optool™ AES4-E” from Daikin Industries Ltd, “Hymocer® EKG 6000N” from ETC Products GmbH, or fluorosilanes under the designations “FSD”, such as “FSD 2500” or “FSD 4500” from Cytonix LLC or Easy Clean Coating “ECC” products such as “ECC 3000” or “ECC 4000” from 3M Deutschland GmbH. These are layers applied in liquid form. Antifingerprint coatings, in the form of nanolayer systems, for example, which are applied by means of physical gas-phase deposition, are available, for example, from Cotec GmbH under the designation “DURALON UltraTec”.

In the continuation of the invention, substrates coated with the products have better properties, especially long-term properties, when applied to the substrate element of the invention. Examples which follow are intended to illustrate this. Following application of the coating, the test substrates were characterized by being subjected to the following tests:

### 1. Neutral Salt Spray Test to DIN EN 1096-2:2001-05 (NSS Test)

A particularly challenging test has emerged as being the neutral salt spray test, in which the coated glass samples are exposed to a neutral salt water atmosphere for 21 days at constant temperature. The effect of the salt water spray mist is to stress the coating. The glass samples stand in a sample holder so that they form an angle of 15±5° with the vertical. The neutral salt solution is prepared by dissolving pure NaCl in deionized water to give a concentration of (50±5)g/l at (25±2°) C. The salt solution is atomized via a suitable nozzle so as to generate a salt spray mist. The operating temperature in the test chamber must be 35±2° C.

The contact angle with water is measured before the test and also after test times of 168 h, 336 h, and 504 h, in order to characterize the stability of the hydrophobic quality. If the contact angle fell below 60°, the test was discontinued, since this correlates with a loss of the hydrophobic quality.

### 2. Contact Angle Measurement

Contact Angle Measurement was Carried Out Using the PCA100 instrument, which allows determination of the contact angles with different liquids and of the surface energy.

The measurement range is from 10 to 150° for the contact angle and from 1×10⁻² to 2×10³ mN/m for the surface energy. Depending on the nature of the surfaces (cleanness, surface uniformity), the contact angle can be determined to an accuracy of 1°. The accuracy of the surface energy is dependent on the precision with which the individual contact angles are located on a regression plot calculated by the method of Owens-Wendt-Kaelble, and is included in the report as a regression value. Samples of any size can be measured, since the instrument is portable and can be placed onto large sheets for the purpose of measurement. The sample must at minimum be large enough to allow a droplet to be applied without coming into conflict with the edge of the sample. The program is able to work with different droplet methods. In this case, the sessile drop method is utilized, and is evaluated using the ellipse fitting method. Prior to the measurement, the sample surface is cleaned with ethanol. Then the sample is positioned, the measuring liquid is applied in droplet form, and the contact angle is measured. The surface energy (polar and disperse components) is determined from a regression line adapted by the method of Owens-Wendt-Kaelble.

To obtain a measure of the long-term durability, a contact angle measurement is carried out after the long-lasting NSS test. For the measurement results reported here, the measuring liquid utilized was deionized water. The error tolerance of the measurement results is ±4°.

### 3. Fingerprint Test

The fingerprint test is used for reproducible application of a fingerprint to a substrate surface and to assess the cleanability.

The test shows the intensity of a fingerprint on a corresponding sample surface. Using a stamp, an imitation, reproducible fingerprint is applied in order to assess the susceptibility of a substrate surface to fingerprint marking. The stamp, with a stamp plate made from solvent-resistant material, has a base area of 3.5×3.9 cm² and has a structure of concentric rings, with a line spacing of about 1.2 mm and a line depth of about 0.5 mm. The following 3 test media are applied to the stamp area:

As a print medium, a hand perspiration solution to BMW test specification 506 was utilized, prepared from 50 g of artificial alkaline perspiration to DIN ISO 105-E04, 2 g of liquid paraffin, 1.5 g of lecithin (Fluidlecithin Super, from Brennnessel, Munich) and 0.3 g of gel-forming agent (PNC400, from Brennnessel, Munich).

To apply the test medium, a felt is impregnated with the medium in a Petri dish and the stamp is pressed onto the impregnated felt with a weight of 1 kg. The stamp is subsequently pressed under 3 kg onto the substrate area to be stamped. Before the beginning of the test, the substrate surface must be free from dust and grease and must be dry. The stamp image as an impression in the form of individual rings must subsequently not be smeared. At least three fingerprints are stamped. Prior to the assessment, the fingerprints are dried for about 12 hours. On evaluation of the print, it ought to be ascertained how much of a print medium is left on the sample surface, and how two-dimensionally it is able to spread out. For this purpose, the print is illuminated with a KL 1500LCD cold-light lamp (from Schott) with annular ring lighting in a camera measurement station, photographed, and processed using image analysis with NI Vision image analysis software. The prints are recorded exclusively without gloss, in order to allow image analysis. Determinations are made of the intensity values of the light scattered by the fingerprint, the scattered light, and the average and breadth of scatter are calculated. The breadth of scatter ought to be less than or equal to 0.065.

### Production Specimen Example Samples 1—Inventive Substrate Element Corresponding to FIG. 1

To prepare the dipping solution, 60.5 ml of tetraethyl silicate, 30 ml of distilled water, and 11.5 g of 1 N nitric acid are added with stirring to 125 ml of ethanol. Following the addition of water and nitric acid, the solution is stirred for 10 minutes, during which the temperature must not exceed 40° C. It may be necessary to cool the solution. The solution is subsequently diluted with 675 ml of ethanol. Added to this solution after 24 hours are 10.9 g of Al(NO₃)₃×9 H₂O in solution in 95 ml of ethanol and 5 ml of acetylacetone.

A scrupulously cleaned sheet of borosilicate float glass 2 in a 10×20 cm format was immersed into the dipping solution. The sheet was withdrawn again at a rate of 6 mm/sec, the moisture content of the surrounding atmosphere being between 5 g/m³ and 12 g/m³, preferably 8 g/m³. The solvent was then evaporated at 90 to 100° C. and the layer thereafter was baked at a temperature of 450° C. for 20 minutes. The thickness of the adhesion promoter layer produced in this way was about 90 nm.

### Production Specimen Example Samples 2—Comparative Sample

For comparison, a conventional silicon coating is to be employed in accordance with the prior art, as the adhesion promoter layer, by the sol-gel dipping method.

To prepare the dipping solution, 125 ml of ethanol are introduced initially. Added thereto with stirring are 45 ml of methyl silicate, 40 ml of distilled water, and 5 ml of glacial acetic acid. Following the addition of water and acetic acid, the solution is stirred for 4 hours, during which the temperature must not exceed 40° C. It may be necessary to cool the solution. The reaction solution is then diluted with 790 ml of ethanol and admixed with 1 ml of HCl.

A scrupulously cleaned sheet of borosilicate float glass in a 10×20 cm format was immersed into the dipping solution. The sheet was then withdrawn again at a rate of 6 mm/sec, the moisture content of the surrounding atmosphere being between 5 g/m³ and 10 g/m³, preferably 8 g/m³. The solvent was then evaporated at 90 to 100° C. and the layer thereafter was baked at a temperature of 450° C. for 20 minutes. The thickness of the layer produced in this way was about 90 nm.

### Production Specimen Example Samples 3—Comparative Sample

A cleaned sheet of borosilicate float glass without adhesion promoter layer was prepared as substrate for a coating with an easy-to-clean coating.

The substrates produced in this way were each coated with easy-to-clean coatings below. The inventive substrates of specimen example 1 carry the designations sample 1-1 to 1-4; the comparative substrates carry the designations sample 2-1 to 2-4 and sample 3-1 to 3-4.

### Sample 1-1, 2-1 and 3-1:

“Optool™ AES4-E” from Daikin Industries Ltd., a perfluoroether with a terminal silane radical

### Sample 1-2, 2-2 and 3-2:

“Fluoroline S10” from Solvay Solexis, a perfluoroether with two terminal silane radicals

### Sample 1-3, 2-3 and 3-3:

For the test of the inventive substrate element for coating with an easy-to-clean coating, an in-house coating formulation was used as well, with the designation “F5”, using Dynasylan® F 8261 from Evonik as precursor. The concentrate was prepared by mixing 5 g of Dynasylan® F 8261 precursor, 10 g of ethanol, 2.5 g of H₂O, and 0.24 g of HCl, and stirring for 2 minutes. 3.5 g of concentrate were mixed with 500 ml of ethanol to give the coating formulation F5.

### Sample 1-4, 2-4 and 3-4:

“Duralon UltraTec” from Cotec GmbH, FrankenstraSe 19, 0-63791 Karlstein

In this coating operation, the glass substrates are treated in a vacuum operation. The glass substrates coated with the respective adhesion promoter layer are introduced into an underpressure vessel, which is subsequently evacuated to low vacuum. Bonded in the form of a tablet (14 mm diameter, 5 mm height), the “Duralon UltraTec” is inserted into an evaporator which is located in the underpressure vessel. The coating material is then evaporated out of this evaporator from the contents of the tablet at temperatures from 100° C. to 400° C., and deposits on the surface of the adhesion promoter layer on the substrate. The time and temperature profiles are set in the manner mandated by Cotec GmbH for the evaporation of the “Duralon UltraTec” material tablet.

In the operation, the substrates obtain a slightly elevated temperature, in the range between 300 K to 370 K.

### Test Results

The samples were investigated before, in the course of, and after the neutral salt spray test (NSS test) and the constant conditions test (CC test). The samples were determined for water contact angle and fingerprint properties before and in the course of the neutral salt spray test (NSS test). The results are set out in tables 1 to 3.

TABLE 1
Results after neutral salt spray test (NSS test)

| | Coating | Duration | | Color |
|---|---|---|---|---|
| Designation | (single-sided) | (h) | Attack | change |
| Sample 1-1 | Optool ™ | 504 h | OK, | Slight |
| | AES4-E | | No attack | |
| Sample 2-1 | Optool ™ | After | Not Ok, | Severe |
| | AES4-E | 168 h | Attack | |
| Sample 3-1 | Optool ™ | After | Not Ok, | Severe |
| | AES4-E | 168 h | Attack | |
| Sample 1-2 | Fluorolink ® | 504 h | OK, | Slight |
| | S10 | | No attack | |
| Sample 2-2 | Fluorolink ® | After | Not OK, | Severe |
| | S10 | 168 h | Attack | |
| Sample 3-2 | Fluorolink ® | After | Not OK, | Severe |
| | S10 | 168 h | Attack | |
| Sample 1-3 | F5 | 504 h | OK, | Slight |
| | | | No attack | |
| Sample 2-3 | F5 | After | Not OK, | Severe |
| | | 168 h | Attack | |
| Sample 3-3 | F5 | After | Not OK, | Severe |
| | | 168 h | Attack | |
| Sample 1-4 | Duralon | 504 h | OK, | Slight |
| | Ultratec | | No attack | |
| Sample 2-4 | Duralon | After | Not OK, | Severe |
| | Ultratec | 168 h | Attack | |
| Sample 3-4 | Duralon | After | Not OK, | Severe |
| | Ultratec | 168 h | Attack | |

Designation: samples 1-X with adhesion promoter layer, samples 2-X with silicon oxide layer as per prior art, samples 3-X without coating

TABLE 2
Water contact angle measurements before and in the course of
the neutral salt spray test (NSS test) as a function of time.

| | | Contact angle measurement in [°] | | | |
|---|---|---|---|---|---|
| | Coating | before | after | after | after |
| Designation | (single-sided) | the test | 168 h | 336 h | 504 h |
| Sample 1-1 | Optool ™ | 102 | 95 | 93 | 90 |
| | AES4-E | | | | |
| Sample 2-1 | Optool ™ | 100 | 58 | — | — |
| | AES4-E | | | | |
| Sample 3-1 | Optool ™ | 104 | 67 | — | — |
| | AES4-E | | | | |
| Sample 1-2 | Fluorolink ® | 102 | 100 | 97 | 98 |
| | S10 | | | | |
| Sample 2-2 | Fluorolink ® | 103 | 56 | — | — |
| | S10 | | | | |
| Sample 3-2 | Fluorolink ® | 105 | 63 | — | — |
| | S10 | | | | |
| Sample 1-3 | F5 | 103 | 89 | 81 | 79 |
| Sample 2-3 | F5 | 103 | 59 | — | — |
| Sample 3-3 | F5 | 101 | 51 | — | — |
| Sample 1-4 | Duralon | 106 | 104 | 102 | 101 |
| | Ultratec | | | | |
| Sample 2-4 | Duralon | 109 | 32 | — | — |
| | Ultratec | | | | |
| Sample 3-4 | Duralon | 104 | 45 | — | — |
| | Ultratec | | | | |

Designation: samples 1-X with adhesion promoter layer, samples 2-X with silicon oxide layer as per prior art, samples 3-X without coating

TABLE 3
Results after fingerprint test with medium 7 hand perspiration
solution BMW before and after three weeks of exposure
by neutral salt spray mist (NSS test).

| | | Medium 7 hand perspiration | |
|---|---|---|---|
| | | solution BWM | |
| | | | Average intensity |
| | | Average intensity | relative to area of |
| | | relative to area of | evaluation after |
| | Coating | evaluation before | 405 h esposure in |
| Designation | (single-sided) | the test | the NSS test |
| Sample 1-1 | Optool ™ | 0.05 | 0.20 |
| | AES4-E | | |
| Sample 2-1 | Optool ™ | 0.06 | 0.25 |
| | AES4-E | | |
| Sample 3-1 | Optool ™ | 0.07 | 0.26 |
| | AES4-E | | |
| Sample 1-2 | Fluorolink ® | 0.06 | 0.13 |
| | S10 | | |
| Sample 2-2 | Fluorolink ® | 0.06 | 0.25 |
| | S10 | | |
| Sample 3-2 | Fluorolink ® | 0.06 | 0.25 |
| | S10 | | |
| Sample 1-3 | F5 | 0.06 | 0.17 |
| Sample 2-3 | F5 | 0.06 | 0.25 |
| Sample 3-3 | F5 | 0.06 | 0.23 |
| Sample 1-5 | Duralon | 0.08 | 0.06 |
| | Ultratec | | |
| Sample 2-5 | Duralon | 0.05 | 0.09 |
| | Ultratec | | |
| Sample 3-5 | Duralon | 0.07 | 0.10 |
| | Ultratec | | |

Designation: samples 1-X with adhesion promoter layer, samples 2-X with silicon oxide layer as per prior art, samples 3-X without coating

The samples with inventive adhesion promoter layer as base for an easy-to-clean coating exhibit no discernible attack (OK=satisfactory) even after a test time of 504 hours, with only slight color change. In contrast, a prior-art sol-gel silicon oxide coating as base for an easy-to-clean coating exhibits severe attack (not OK=unsatisfactory) after a test time of just 168 hours, with severe color change. The stability of the ETC layer in the NSS test could be extended to more than 21 days without visible attack as a result of application to the substrate of the invention.

In all of these cases, the inventive adhesion promoter layer on a substrate as basis for the different easy-to-clean coatings imparts a significant improvement in their long-term stability. In comparison, an easy-to-clean coating on a substrate without adhesion promoter layer shows a loss in hydrophobic quality in all cases after just 168 hours in the NSS test. For the maintenance of a high contact angle, for easy-to-clean properties that are relevant in practice, said angle ought to be more than 80°. This was seen as a good indicator for determining the maintenance of the properties after an exposure test. The NSS test, as a widely acknowledged test, is one of the critical tests for coatings of this kind. It reflects exposures which come about as a result, for example, of contact with fingerprints. The salt content of finger perspiration is a typical influencing factor in coat failure. The long-term stability is considered to be a critical property. Overall, a lower antifingerprint property with longer stability is classed better than a very good antifingerprint property with deficient long-term stability. The NSS test has a significant relevance in relation to actual touch applications and outdoor applications of, for example, touch panels and touchscreens.

Following the application of an easy-to-clean coating to the adhesion promoter layer of the invention, the water contact angle with respect to the easy-to-clean coating is higher, after a more than three times longer exposure in the neutral salt spray test, than for the same easy-to-clean coating applied without an adhesion promoter layer, with correspondingly shorter exposure in the neutral salt spray test. For a drop in the water contact angle in the long-term NSS test of up to 10%, the easy-to-clean coat is not yet substantially attacked; for a drop in the water contact angle to less than 50°, the conclusion can be drawn that the easy-to-clean layer is no longer in existence, or exists only in a strongly damaged form, and its effect is compromised.

For instance, the measurement results in table 2, for all of the various easy-to-clean coatings on a clean glass surface or on a silicon oxide coating according to the prior art, show a substantial to complete compromising of the easy-to-clean or antifingerprint quality after just 7 days, whereas the same coatings on the adhesion promoter layer of the invention have retained their activity, in some cases fully, after even 21 days.

From the results it is apparent that for all of the organofluorine compounds investigated, the inventive substrate element with adhesion promoter layer produces a significant prolongation of stability.

In spite of this it is naturally possible to observe differences between the various easy-to-clean systems, since, in addition to the adhesion promoter layer, the basic resistance of the easy-to-clean layer also has an influence on the stability. Independently of the particular organofluorine compound, however, a consistent effect is observed that brings about a significant improvement to the long-term effect, in particular, of an easy-to-clean coating. This effect comes about through the interaction between the easy-to-clean coating and the adhesion promoter layer.

Antifingerprint test results confirm the advantage of the inventive substrate elements as a basis for an easy-to-clean coating. For the samples with and without adhesion promoter layer before and after 17-day exposure in the neutral salt spray test (NSS test), table 3 shows the analysis of the intensity of the scattered light of the applied standard fingerprint. Depending on the nature of the ETC coating, the results show an improvement in the antifingerprint quality even directly after coating. In particular, however, the results show a significant improvement in the AFP quality after long-term exposure in the NSS test; in other words, the AFP effect of an ETC coating has significantly greater long-term stability when using an inventive substrate element for the coating than for a conventional substrate without an adhesion promoter layer.

Inventive substrate elements coated with an easy-to-clean coating are employed as a covering with a protective function. In this context, all base materials of the conventional coverings and protective apparatus can be used as support material for a substrate element of the invention, and can be provided with an adhesion promoter layer and easy-to-clean coating.

Inventive substrate elements coated with an easy-to-clean coating are also employed as a substrate with touch function. Support material contemplated includes all suitable materials such as metals, plastics, glasses, or composite materials that are equipped with a touch function. A prominent position is occupied here in particular by displays with a touchscreen function. Especially deserving of emphasis here is the long-term stability with respect to abrasion and chemical attack in the form of finger perspiration such as salts and fats.

Examples of applications are display screens of monitors or display front screens, employed in each case as a front screen with an air gap or as a front screen bonded directly onto a display screen, optionally with polarizer incorporated by lamination.

Substrate elements of the invention that are coated with an easy-to-clean coating may be used for all kinds of display applications, such as display applications with touchscreen function as single-touch, dual-touch, or multitouch displays, 3D displays, or flexible displays.

Substrate elements of the invention that are coated with an easy-to-clean coating are used as substrate for all kinds of interactive input elements, especially those configured with a touch function, preferably with resistive, capacitive, optical or infrared or surface acoustic wave touch technology. Systems which operate with incoupling of light, in particular, such as infrared or optical touch technologies, react sensitively to the presence of dirt and deposits on the contact surface, since deposits here may give rise to undesirable reflections. The use of a substrate element of the invention coated with an easy-to-clean coating has particular advantages here.

Other applications with long-term-stable ETC or AFP qualities are screens in interior and exterior architecture, such as display windows, glazing of pictures, shop fronts, kiosks, refrigeration furniture, or glazing that is difficult to access for cleaning. In the architectural sector, as well as the high adhesion, scratch resistance, and long-term stability, the UV stability of the ETC layer is also important.

Other applications are, for example, oven front plates, decorative glass elements, especially in exposed areas with a relatively high risk of contamination such as kitchens, bathrooms, or laboratories, or else covers of solar modules.

Inventive substrates coated with an easy-to-clean coating, in some cases also with an etched support material surface, find use as utility surfaces with antifingerprint, antigraffiti, or antiglare properties.

Especially decorative elements which have printing on the reverse of the glass or have a mirror coating profit particularly from an easy-to-clean coating. These elements, which are used, for example, as oven front plates or in other kitchen equipment, come into contact continually, during service, with fingerprints or fatty substances. In such cases, the surface very quickly looks unappealing and unhygienic. The easy-to-clean coating already produces good visual results here, for suppression, and can be cleaned more easily. As a result of the substrate of the invention in such an application, the long life of the effect can be boosted significantly and the utility value of an article is increased.

It will be appreciated that the invention is not confined to a combination of features described above, but instead that the skilled person will combine arbitrarily all features of the invention, provided it is rational to do so.

1-24. (canceled)

25. A substrate element for coating with an easy-to-clean coating, comprising
a support material; and
a coating, wherein the coating consists of an adhesion promoter layer comprising a mixed oxide that is covalently bondable with an easy-to-clean coating.

26. The substrate element as claimed in claim 25, wherein the adhesion promoter layer is selected from the group consisting of a liquid-phase coating, a thermally consolidated sol-gel layer, a CVD coating, a flame pyrolysis layer, a PVD coating, and a sputtered layer.

27. The substrate element as claimed in claim 25, wherein the adhesion promoter layer is subdivided into sublayers by one or more interlayers.

28. The substrate element as claimed in claim 27, wherein the one or more interlayers have a thickness of 0.3 to 10 nm

29. The substrate element as claimed in claim 27, wherein the one or more interlayers have a thickness of 1 to 3 nm.

30. The substrate element as claimed in claim 25, wherein the adhesion promoter layer has a refractive index in the range from 1.35 to 1.7.

31. The substrate element as claimed in claim 25, wherein the adhesion promoter layer has a refractive index in the range from 1.35 to 1.56.

32. The substrate element as claimed in claim 25, wherein the adhesion promoter layer is a silicon oxide layer mixed with an oxide of at least one element selected from the group consisting of aluminum, tin, magnesium, phosphorus, cerium, zirconium, titanium, cesium, barium, strontium, niobium, zinc, boron, magnesium fluoride, and combinations thereof.

33. The substrate element as claimed in claim 25, wherein the adhesion promoter layer has a thickness of greater than 1 nm.

34. The substrate element as claimed in claim 25, wherein the adhesion promoter layer has a thickness of greater than 20 nm.

35. The substrate element as claimed in claim 25, further comprising an outer layer disposed over the adhesion promoter layer.

36. The substrate element as claimed in claim 35, wherein the outer layer is a particulate layer or a porous layer.

37. The substrate element as claimed in claim 35, wherein the outer layer consists of silicon oxide or a silicon mixed oxide.

38. The substrate element as claimed claim 25, wherein the support material is a made of a material selected from the group consisting of metal, plastic, crystal, ceramic, glass, glass-ceramic, and composite material.

39. The substrate element as claimed in claim 25, wherein the support material is made of a material selected from the group consisting of a lithium aluminum silicate glass, a soda-lime silicate glass, a borosilicate glass, an alkali metal aluminosilicate glass, an alkali-metal-free aluminosilicate glass, and low-alkali-metal aluminosilicate glass.

40. The substrate element as claimed in claim 25, wherein the support material comprises a structured surface.

41. The substrate element as claimed in claim 25, further comprising an easy-to-clean coating covalently bonded to the adhesion promoter layer, the easy-to-clean coating having a water contact angle that is, after exposure in a neutral salt spray test, higher than 1.5 times then the same easy-to-clean coating applied without the adhesion promoter layer.

42. A method for producing a substrate element for coating with an easy-to-clean coating, comprising the following steps:
providing a glass or a glass-ceramic support material having at least one surface;
coating the at least one surface by a sol-gel application technology with an adhesion promoter precursor layer;
thermally consolidating the adhesion promoter precursor layer and converting the adhesion promoter precursor layer into an adhesion promoter layer, the adhesion promoter layer comprising a silicon oxide mixed with an oxide of at least one element selected from the group consisting of aluminum, tin, magnesium, phosphorus, cerium, zirconium, titanium, cesium, barium, strontium, niobium, zinc, boron, and magnesium fluoride.

43. The method as claimed in claim 42, wherein the thermal consolidating and converting take place at a temperature below a softening temperature of the support material.

44. The method as claimed in claim 43, wherein the temperature is less than 550° C.

45. The method as claimed in claim 42, wherein the thermal consolidating and converting take place in situ with a heat treatment of the support material.

46. The method as claimed in claim 42, wherein the thermal consolidating and converting are preceded by drying of the adhesion promoter precursor layer at a temperature of less than 300° C.

47. The method for as claimed in claim 42, further comprising applying an outer layer over the adhesion promoter layer by flame pyrolysis, wherein the outer layer consists of silicon oxide or of a silicon mixed oxide, and wherein the outer layer is a particulate layer or a porous layer.
